(19) United States
(12) Patent Application Publication
(10) Pub. No.: US 2009/0194661 A1
(43) Pub. Date: Aug. 6, 2009

(54) COMPOSITE POLE

(76) Inventor: Damian McCue, New South Wales (AU)

Correspondence Address: REED SMITH LLP, P.O. BOX 488, PITTSBURGH, PA, 15230-0488, US

(21) Appl. No.: 12/280,459

(22) PCT Filed: Feb. 15, 2007
(86) PCT No.: PCT/AU2007/000166

§ 371 Date: Apr. 10, 2009

(30) Foreign Application Priority Data
Feb. 15, 2006 (AU) 2006900747

(51) Int. Cl. E04H 12/34; B23P 6/00

(52) U.S. Cl. 248/523; 29/897.1

(57) ABSTRACT

The present invention provides for a pole support or replacement section for a pole (5). The pole support or pole replacement section has a sleeve (1), the sleeve defining a cavity (2) adapted to receive and engage a lower end of the pole (5) so as to provide contiguity between the sleeve and the pole. The invention also relates to a composite pole comprising a supporting assembly and a pole. A method of restoring or extending a pole is also disclosed.

### TECHNICAL FIELD

The present invention relates to support structures for poles, in particular for utility poles that find application as poles for electric power and telephone transmission lines, foundation and marine poles and other heavy-duty timber applications.

### BACKGROUND OF THE INVENTION

Any discussion of the prior art throughout the specification should in no way be considered as an admission that such prior art is widely known or forms part of common general knowledge in the field.

Utility poles are commonly used in a variety of industries. However, timber poles in particular are prone to deterioration over a period of time due to termite attack, fungal decay, exposure to moisture and the like. The subsequent weakening of the poles has serious consequences, as the poles are likely to collapse. Deterioration in power poles is of particular concern as the fallen or crossed wires attached to collapsed poles can spark and set off fires.

Traditionally timber has been treated with preservatives or insecticides to minimise deterioration. However some treatments are not always completely effective. Further, due to environmental concerns there are a number of practical and legal restrictions on use of these chemicals. Thus chemical treatment alone cannot provide a satisfactory solution to environmental deterioration of timber poles in every case. Deteriorating poles are often cut off at the base to remove the damaged portion. This leads to a shorter pole, which has to be lengthened to reuse the pole. There is also a shortfall in key pole sizes in the industry at large and it is frequently required to utilise readily available shorter poles, which again require to be lengthened whilst retaining structural integrity.

Previous efforts to restore or extend poles entailed raising an existing pole vertically so that the lower end of the pole could receive a concrete support stub. A sliding steel sleeve enveloped the lower end of the pole and the upper end of the concrete stub. The pole and stub was then re-established in the ground such that the concrete stub was located inground. Where required, existing poles could also be cut and re-established in this manner. The stability of this pole was reliant on the compressive strength of the concrete.

Alternatively, as disclosed in AU 41796/85, a corrosion resistant pole stub or insert member is fitted to a timber pole. The stub is fitted with a steel sleeve or collar so as to form a cavity, which cavity contains a non-compressible material like concrete. Thereby the pole replacement section constitutes a part of the pole. Such a pole replacement section is said to withstand environmental deterioration and also increase the compression strength of the concrete. The concrete is required to be poured into the sleeve to the desired depth and set before using the pole replacement section.

AU 79383/87 also provides for a pole replacement section comprising a steel sleeve partially filled with a non-compressible material and defining a cavity, which can receive an end of a pole. Additionally, the sleeve has wedging means e.g. spring steel bars located within the cavity, which assists the location of the pole within the cavity. The sleeved section is used to enhance the compression strength of the concrete within the sleeve.

AU 33270/89 provides for a pole replacement section that is a sleeve with a first and second end section. The first section is formed in a divergent manner so as to receive a pole. The sleeve is an open-ended sleeve that can be partially or completely filled with a compressible or incompressible material.

Concrete is used in the industry as it reduces buckling of the pole, passivates a galvanised steel sleeve to reduce condensation and/or corrosion and serves the purpose of reducing fungal decay or termite attack. However, the use of concrete in the poles poses several problems. Firstly, concrete and similar non-compressible materials like sand are heavy which adds to the difficulty and cost of transporting such poles/pole replacements. Secondly the process of preparing such replacements by pouring in the concrete and allowing it to set is cumbersome and time consuming.

Therefore there remains a need to provide for a pole support or pole replacement section that provides a base for a pole which is sufficient to comply with industry standards for strength and stability, is resistant to corrosion, attack by fungi, insects or moisture and is easy to assemble and transport.

It is an object of the present invention to overcome or ameliorate at least one of the disadvantages of the prior art, or to provide a useful alternative.

It is an object of the invention in its preferred embodiment to provide for a pole support or replacement section that provides a strong base, is substantially resistant to environmental deterioration when placed substantially or partially below ground level, is easy to assemble and transport and is cost effective, can be used in any soil condition and minimises the use of non-compressible materials like concrete or sand. It is an object of the invention, in yet another preferred embodiment, to provide a pole support or replacement section that is a substitute base for a section of a utility pole weakened by deterioration in use and to reduce the number of inspection visits to check deterioration of utility poles.

### DISCLOSURE OF THE INVENTION

The present invention provides for a pole support or replacement section for a pole including:

a sleeve of a substantially non corrosive material, said sleeve defining a cavity adapted to receive and engage a lower end of said pole so as to provide contiguity between said sleeve and said pole.

Preferably the cross-section of the sleeve is keyed to the cross section of the pole.

Preferably, the sleeve is hollow and cylindrical and does not include a non compressible material.

Preferably, the receiving sleeve has a base and includes apertures.

Preferably, the substantially non-corrosive material is galvanised steel.

The present invention also provides for a composite pole including:

a supporting assembly; and

a pole;

wherein said supporting assembly includes a sleeve of a substantially non corrosive material and said sleeve defines a cavity that receives and engages a lower end of said pole so as to provide contiguity between said sleeve and said pole.

Preferably the sleeve is hollow and does not include a non-compressible material.

Preferably the pole is a timber pole and more preferably the supporting assembly and the pole are in releasable engagement.

The present invention also provides for a method of restoring or extending a pole comprising the steps of:

independently supporting said pole as necessary;

optionally removing a weakened part of said pole;

sizing said pole as required for reception into a cavity of a sleeve of a substantially non-corrosive material; and

bringing a lower end of said pole and upper end of said sleeve in co-aligned end-to-end registration such that said pole is received and engaged by said cavity thereby to provide contiguity between said sleeve and said pole.

Preferably the pole is a load bearing pole.

The composite pole assembled by the method of the invention can be established in soil already prepared to receive the pole such that when established, the sleeve is substantially or partially below ground level. In alternate methods, the sleeve can be introduced into the soil such that it is substantially or partially below the ground level and the pole then introduced into the cavity of the sleeve. In other embodiments, the pole can be an existing pole that is removed from the soil and supported as required. The deteriorating part is then excised. The sleeve is introduced into the soil such that it is substantially or partially below ground level and the excised pole is then introduced into the cavity of the sleeve.

### BRIEF DESCRIPTION OF THE DRAWINGS

FIG. 1 is a vertical cross section through a composite pole according to the invention.

FIG. 2 is a front view of the composite pole of FIG. 1.

FIG. 2a is a view of the base of a sleeve according to the invention.

FIG. 3 is an alternative embodiment of the invention.

FIGS. 4a-4c are further alternative embodiments of the invention.

FIGS. 5 & 6 are vertical cross sections through a composite pole according to the invention.

### PREFERRED EMBODIMENT

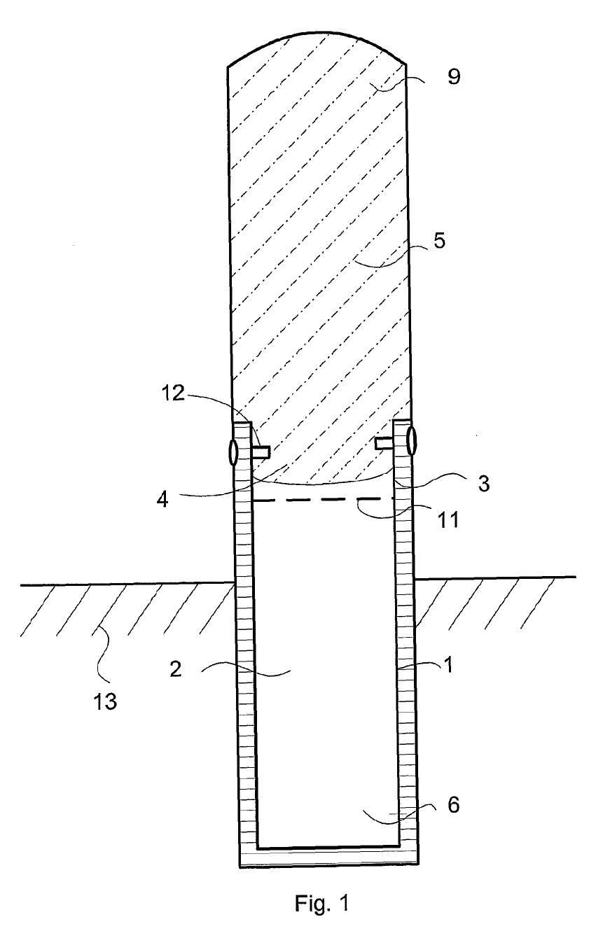

Referring to FIG. 1, a sleeve 1 of a pole support or replacement section is made of a substantially rigid and non-corrosive material and is substantially hollow and defines a cavity 2. Sleeve 1 has an upper portion or upper end 3 adapted to receive and engage a lower end 4 of a timber pole 5 so as to provide contiguity between the sleeve 1 and the pole 5. The cavity 2 is substantially free of non-compressible material.

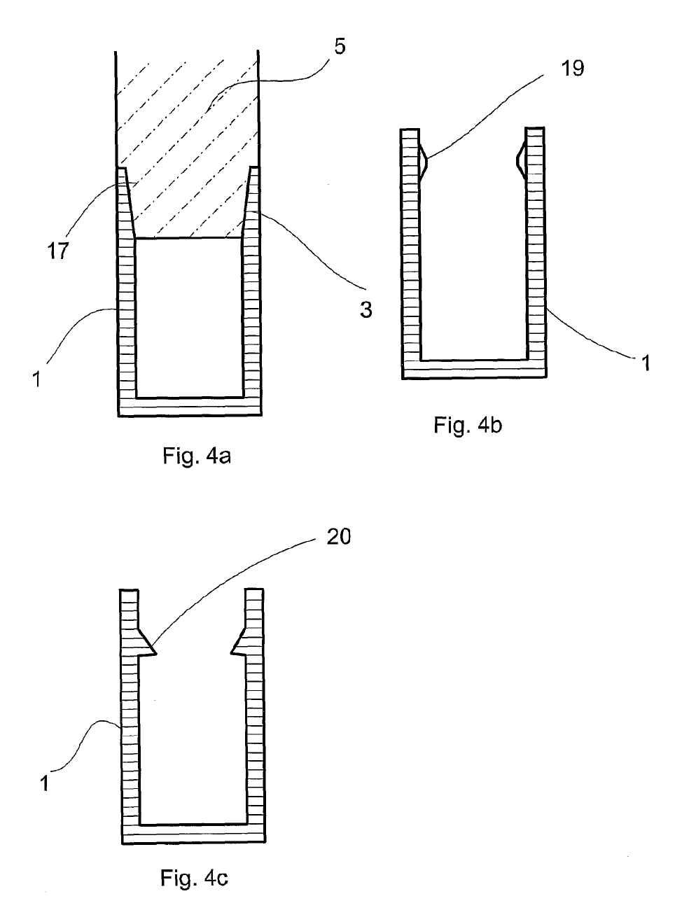

The dimensions of the sleeve 1, for example the length, will depend on the height and dimensions of the pole 5. The sleeve may be of constant cross section corresponding to the pole (or its lower end portion 4). FIG. 3 shows cross sections A and B through A′-A″ and B′-B″ respectively. While the cross section can be circular, hexagonal, octagonal or any suitable shape, a circular cross section is preferred. In the most preferred embodiment, the sleeve 1 is a suitable length of a cylindrical pipe. The size, length, material and wall thickness of the sleeve 1 are selected in combination to provide a sleeve that enables a pole of given size to comply with Australian standard AS/NZS 4676 or any equivalent standard.

The sleeve 1 is of a uniform size and is ideal as a pole support or replacement section in places where hole size restrictions are in place. The sleeve may be a material of suitable durability, strength and resistance having regard to factors such as soil condition, erosion, corrosion and likelihood of environmental damage. Preferably the substantially rigid and non-corrosive material is steel, more preferably galvanised steel. In most preferred embodiments, the sleeve is a galvanised steel like 350 Grade steel or 450 Grade steel. Galvanised steel sleeves are seen to reduce corrosion, add to durability and extend groundline inspection periods. There is also increased resistance to fires. Further protection from corrosion is possible by painting, zinc spraying or epoxy coating the sleeve. This is represented as 14 in FIG. 3. It is also possible to apply a sacrificial anode 15 to the sleeve so that any corrosion will take place on the sacrificial layer leaving the sleeve intact. The steel sleeve also provides for progressive collapse mechanism for the pole preventing catastrophic failure of the pole. In alternate embodiments, the sleeve can be a suitable plastic material.

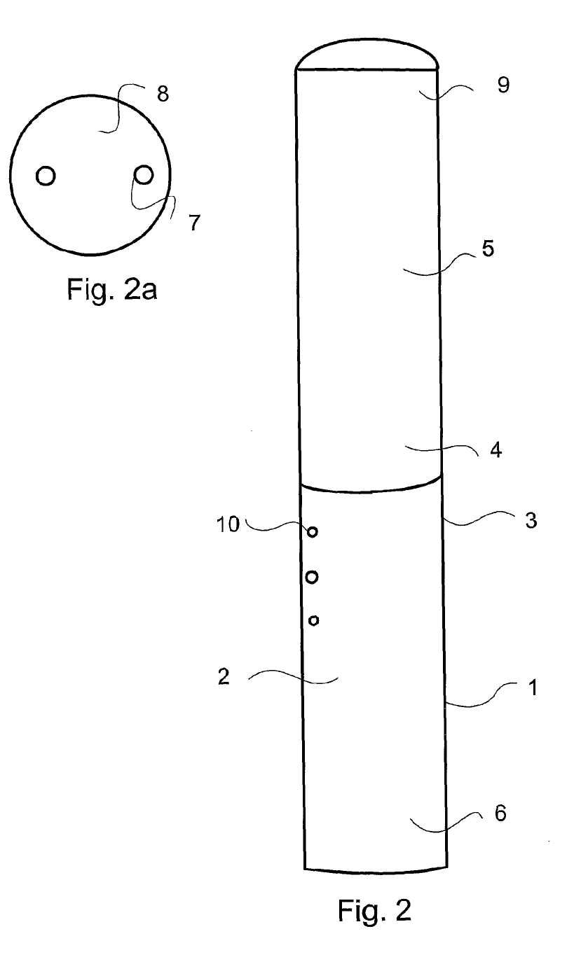

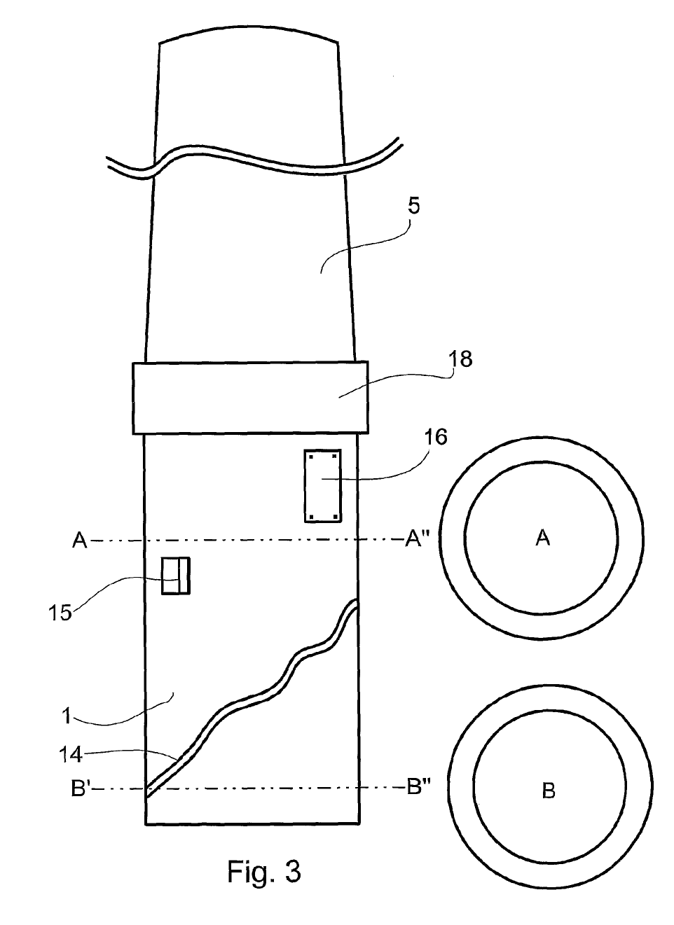

A lower end 6 of sleeve 1 has drainage or grout apertures 7 on a plated bottom 8 for draining any excess material as best illustrated in FIG. 2a. Apertures may also be present on the lower end 6. In the most preferred embodiments, pole 5 is a power or telephone transmission pole and is adapted to carry an elevated system of wiring (not shown) attached at upper end 9.

Apertures 10 may also be present on the sleeve. These serve as inspection sites for periodic observation of the deterioration of the timber pole. If desired they may be covered by a removable inspection plate 16 or the like. They can also be used to add non-compressible material like concrete or sand if required. The non-compressible material can be added, for example, at the site of installation. The addition of such material may be desirable when securely establishing the pole support or replacement section in poor soils. Corrosion and timber deterioration preventing films can also be sprayed inside the sleeve 1 though the apertures 10.

It is also possible to include an insect barrier means 11, at the junction of sleeve 1 and pole 5. This may be for example a chemical or physical barrier, such as a termite mesh. This reduces the likelihood of termites and the like causing deterioration of the timber pole 5. To further reduce deterioration, the timber pole may also be treated along its entire or partial length with a suitable preservative and/or insecticide. For example the pole can be treated with Tanalith® E (Copper Azole) which contains copper and an organic fungicide as its active to assist in protection against insects and fungal decay.

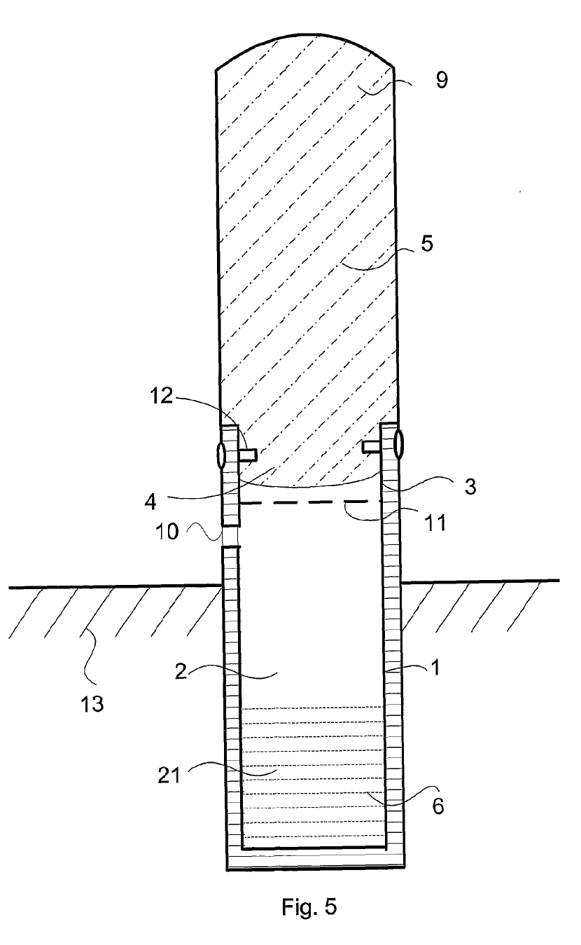

An advantage of the pole support or replacement section according to the invention is that no tight dimensional tolerances are required. The firm and continuous engagement of the lower end 4 of the pole 5 in sleeve 1 can be further assisted by mechanical fastening means like galvanised coach screws 12 after compression fitting of the pole into the sleeve. In alternate embodiments the fastening means can include bolts, nails and the like. An optimal number of coach screws e.g. three, six or nine can be used. The upper and lower ends of the pole may be tapered if required to assist in firm engagement with sleeve 1. This can be seen in FIG. 3 which shows a pole tapered at the top. In FIG. 4a the pole 5 has a bottom tapered portion 17 for engaging with an upper portion 3 of sleeve 1.

As seen in FIG. 3, it is also possible to introduce a junction means in the form of a collar 18 with suitable connections to sleeve 1 and pole 5 so as to further reinforce the contiguity between the sleeve and the pole. The junction means can be peripherally continuous or discontinuous and may be integral or otherwise with sleeve 1. In alternate embodiments, as seen in FIG. 4b, a spring or resilient member 19 can also be attached in the cavity of sleeve, which engages the end of the pole 5 to further “rigidify” the sleeve and to increase the contiguity of the sleeve and the pole. The wedge configuration 20 of FIG. 4c may also be employed.

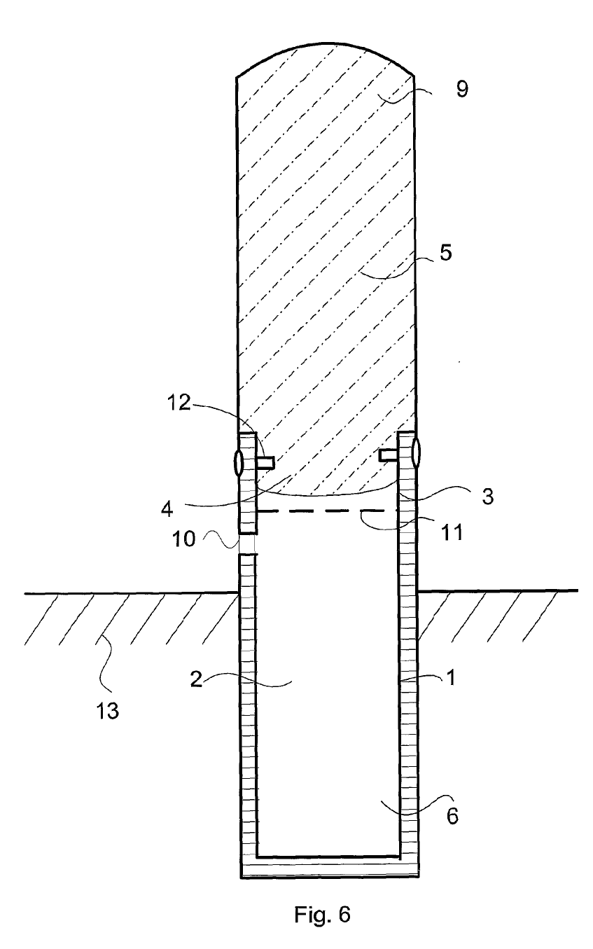

In alternate embodiments, as seen in FIG. 5, the sleeve 1 can be partially filled with a non-compressible material 21 like sand.

The pole support or replacement section i.e. the sleeve 1 can be used as a firm supporting base for a new pole or as a replacement base for an existing pole whose base has weakened or rotted.

Sleeve 1 and pole 5 are so fitted so that one constitutes a substantially rigid continuation of the other. Sleeve 1 and pole 5 are releasably joined to form the composite pole according to the invention. The pole 5 can be removed when required by way of upward movement of the upper end 9. In the composite pole, the timber pole 5 is not in contact with the ground, thus significantly reducing deterioration.

In highly preferred embodiments, the composite pole length can be 11.0 m to 23.0 m and strength can be 6-12 KN.

By use of a composite pole where the sleeve 1 is substantially or partially below ground level, lower timber preservative treatment becomes viable. Further, timbers which are traditionally not used, for example lower durability class species of timber poles, can be used in above ground hazard level (commonly known as H3) exposure conditions. In this way treating the pole to a higher treatment level (for e.g. H5) can be avoided.

In use, a load bearing pole is restored or extended by independently supporting pole 5 as necessary and sizing the pole as required. The lower end 4 of pole 5 is then brought into co-aligned end to end registration with upper end 3 of the sleeve 1 so that lower end 4 is received and engaged by the cavity 2 thereby to provide contiguity between the sleeve 1 and the pole 5.

In one embodiment the sleeve 1 is partially inserted into a prepared hole in soil 13. The sleeve acts as a support base for new pole 5. The lower end 4 of pole 5 may be tapered so as to be easily located in the cavity 2.

In an alternate embodiment, the sleeve and pole can be assembled prior to placing it in a prepared hole in the soil 13. The lower end 4 of pole 5 is received and engaged by the upper end 3 of sleeve 1. The composite pole so assembled is then inserted into the soil such that the sleeve 1 is partially visible. In alternate embodiments, the sleeve is substantially inserted into the soil.

In other embodiments, the pole 5 can be an existing pole that is removed from the soil and supported as required. An intermediate portion of the pole 5 is gripped by a gripping means so as to bear the effective weight of the pole in controlled stable alignment. The pole is then disengaged from the ground and the deteriorated portion removed. The pole is then sized as required. The pole is then brought into co-aligned end-to-end registration with the upper end 3 of sleeve 1 so that the sleeve constitutes in effect a substantially rigid extension and support portion of the pole. The composite pole is then re-established in the soil 13 such that the sleeve 1 is substantially or partially below ground level.

When the timber pole 5 is a power pole adapted to carry an elevated system of wiring attached to an upper portion 9 of the pole, the composite pole can be established by the method of the invention without removing any such wiring.

It is likely the sleeve 1 will have a longer life than pole 5. Accordingly, as and when required the pole can be removed and reused or a new pole introduced.

The invention therefore provides for a simple pole support or replacement section which provides a strong base for a pole, is substantially resistant to environmental deterioration when placed substantially or partially below ground level, is easy to assemble and transport and is cost effective, can be used in any soil condition and minimises the use of non-compressible materials like concrete or sand. Replacement of existing poles as well as reuse of existing utility poles weakened by deterioration in use is also possible. The composite pole of the invention also reduces the number of inspection visits necessary to check deterioration of utility poles.

Although the invention has been described with reference to a specific example, it will be appreciated by those skilled in the art that the invention may be embodied in many other forms.

1-65. (canceled)

66. A pole support or replacement section for a pole including:
a sleeve of a substantially non corrosive material, said sleeve defining a cavity adapted to receive and engage a lower end of said pole so as to provide contiguity between said sleeve and said pole.

67. A pole support or replacement section for a pole according to claim 66 wherein said sleeve has at least one aperture.

68. A pole support or replacement section for a pole according to claim 67 wherein said sleeve has a lower portion and an upper portion, said upper portion being adapted to receive and engage a lower end of said pole, and said at least one aperture is located in said upper portion of said sleeve.

69. A pole support or replacement section for a pole according to 67 wherein said at least one aperture is substantially covered by a removable plate.

70. A pole support or replacement section for a pole according to claim 66 wherein said sleeve is hollow.

71. A pole support or replacement section for a pole according to claim 66 wherein said sleeve is substantially free of a non-compressible material.

72. A pole support or replacement section for a pole according to claim 66 wherein said sleeve has a base.

73. A composite pole including:
a supporting assembly; and
a pole;
wherein said supporting assembly includes a sleeve of a substantially non corrosive material and said sleeve defines a cavity that receives and engages a lower end of said pole so as to provide contiguity between said sleeve and said pole.

74. A composite pole according to claim 73 wherein an upper end of said sleeve is adapted to receive and engage and a lower end of said pole so as to provide contiguity between said supporting assembly and said pole.

75. A composite pole according to claim 73 wherein said sleeve and said pole are in releasable engagement.

76. A composite pole according to claim 73 wherein said sleeve has at least one aperture.

77. A composite pole according to claim 76 wherein said sleeve has a lower portion and an upper portion, said upper portion being adapted to receive and engage a lower end of said pole, and said at least one aperture is located in the upper portion of said sleeve.

78. A composite pole according to claim 76 wherein said at least one aperture is substantially covered by a removable plate.

79. A composite pole according to claim 73 wherein said sleeve is hollow.

80. A composite pole according to claim 73 wherein said sleeve is substantially free of non-compressible material.

81. A composite pole according to claim 73 further including a barrier means at the junction of said supporting assembly and said pole.

82. A method of restoring or extending a pole comprising the steps of:
independently supporting said pole as necessary;
optionally removing a weakened part of said pole;
sizing said pole as required for reception into a cavity of a sleeve of a substantially non-corrosive material; and
bringing a lower end of said pole and upper end of said sleeve in co-aligned end-to-end registration such that said pole is received and engaged by said cavity thereby to provide contiguity between said sleeve and said pole.

83. The method of claim 82 wherein said pole is disengaged from an area where it was previously established and sized as required.

84. The method of claim 83 wherein said pole is brought into co-aligned end-to-end registration with the upper end of said sleeve so that the sleeve constitutes in effect a substantially rigid extension and support portion of said pole so as to form a composite pole.

85. The method of claim 84 wherein said composite pole is re-established in a suitable area such that said sleeve is substantially or partially below ground level.
